(19) United States
(12) Patent Application Publication
(10) Pub. No.: US 2017/0224095 A1
(43) Pub. Date: Aug. 10, 2017

(54) Variable grip pen sleeve

(71) Applicant: James Joseph Redfern, Victoria (CA)

(72) Inventor: James Joseph Redfern, Victoria (CA)

(21) Appl. No.: 14/998,732

(22) Filed: Feb. 9, 2016

(51) Int. Cl. A46B 5/02; B43K 21/00; B43K 7/00; B43K 23/008

(52) U.S. Cl. CPC A46B 5/026; B43K 23/008; B43K 21/006; B43K 7/005

(57) ABSTRACT

An improved hand held pen holding sleeve comprising a rigid barrel with a through bore abutting a deformable finger grip element also with a through bore. The pen holding sleeve is devoid of an ink reservoir or ink cartridge. The through bore of the pen holding sleeve is sized and configured to accept disposable stick pens and common pencils as the refill element. The deformable finger grip element is removable from the rigid barrel. The deformable finger grip element, formed of an elastomer, is the sole means for capturing and retaining the refill element within the pen holding sleeve.

### CROSS REFERENCE TO RELATED APPLICATIONS

This patent claims the benefit of provisional patent application Ser. No. U.S. 62/176,121 filed Feb. 10, 2015 by the present inventor.

### FEDERALLY SPONSORED RESEARCH

Not applicable

### SEQUENCE LISTING OR PROGRAM

Not Applicable

### BACKGROUND OF THE INVENTION

### Field of Invention

This invention relates to an ergonomic writing instrument having a removable finger gripping element in the finger contact zone.

### Prior Art

Annually billions of pens are manufactured with ergonomic features to enhance tactility and provide comfort for the user. However, one of the best selling pen categories, disposable stick pens, have little to no ergonomic features built in to them to provide users comfort or enhanced tactility.

Prior art designed as aftermarket devices to enhance stick pens and common pencils come in the form of pen gripping sleeves. The pen gripping sleeves currently available are one piece designs made of a single material. They are designed to be removable from the independent pen or pencil they have been slid onto, consequently they are reusable.

Pen gripping sleeves previously known suffer from a number of commonly shared disadvantages.
a) The sleeves are primitive and unattractive in design.
b) They are simplistic, lack substantial mass, balance and effective ergonomic features.
c) Prior art is not particularly comfortable as they are made of materials of relatively high durometer such as silicone, vinyl or rubber.
d) Prior art lacks adequate surface area for promotional printing.
e) Individual models offer limited sizes in the finger contact zone, if at all.

Prior art has generally been made of silicone, vinyl or rubber which are materials that are flexible but cannot be considered soft. Although prior art offers enhanced tactility it cannot be said the materials used offer comfort. In addition, due to unimaginative, simplistic design they have no functional flexibility. For example, they are not effective as promotional platforms because their outer surface area is limited therefore cannot receive printed indicia.

Numerous solutions have been proposed. For example:
U.S. Pat. No. 2,173,451 to Lorber (1939)
U.S. Pat. No. 4,167,347 to Hoyle (1979)
U.S. Pat. No. 4,601,598 to Schwartz et al (1986)
U.S. Pat. No. 4,030,841 to Ballasty (1977)
U.S. Pat. No. 7,334,298 to Willat et al (2008).
U.S. Pat. No. 1,971,681 to Hauton (1934)
U.S. Pat. No. 6,752,556 B2 Pearce (2004)

The reader can see from these examples that the proposed designs are unattractive and simplistic. At least one makes claim to provide a stylish appearance yet prior art does little for the aesthetic enhancement of pen products they are to be placed on. In addition, minimal surface area is provided for effective printing of promotional logos and messages.

Some manufacturers have offered elastomeric pen grip sleeves composed of softer material such as foam rubber. A significant problem exists with removable pen grips made of soft materials of a low durometer such as tubular foam rubber. They possess a high coefficient of friction within their internal bore. This internal friction offered by the inside walls of low durometer pen grip sleeves can make it difficult to insert pens or pencils into the bore of a foam grip, especially one made of soft foam rubber. If the foam grip sleeve were made to nearly the entire length of the stick pen the internal friction would be so great that it would be very difficult, in some cases impossible, to insert a stick pen or pencil into the foam pen grip sleeve.

To minimize the internal radial friction within the internal diameter of the pen grip sleeve manufacturers have minimized the length of their foam rubber, silicone, rubber or vinyl grip. Thus the shorter the grip, the less the internal friction, therefore the less difficult it would be to insert a pen into the elastomeric pen grip sleeve. Currently pen gripping sleeves offered by manufacturers are approximately 1.5 inches to 2 inches in length and only cover a limited portion of the pen or pencil around the finger contact zone. This is not to the advantage of the user. Because prior art does not extend to nearly the entire length of the stick pen they are: a) visually unappealing b) offer limited ergonomics and c) possess limited surface area. As previously mentioned this precludes the ability to print or stamp indicia onto the pen gripping sleeve.

Constructing pen gripping sleeves of shortened length and of a single material does not lend itself to enhanced ergonomics, aesthetics, promotional ability or the production of multicoloured, multi-material, sophisticated pen grip sleeve designs.

### Objects and Advantages

Although others have invented writing instrument holders or pen gripping sleeves in an attempt to enhance the comfort, ergonomics and tactility of disposable stick pens and common pencils there are several objects and advantages of the present invention. These are:
a) To provide a pen gripping sleeve with the ability to remove the finger grip element and replace it with other grip elements of varying sizes and materials.
b) To provide a pen gripping sleeve that slides over the substantial length of a disposable stick pen or common pencil for improved balance.
c) To provide a pen gripping sleeve that is attractive appearance.
d) To provide a pen gripping sleeve constructed of at least two differing materials for more sophisticated design; a deformable elastomer in the finger contact area removably attached to a rigid barrel that forms the remaining length of the gripping sleeve implement.
e) To provide a pen gripping sleeve that offers an adequate surface area on the rigid barrel element upon which promotional text or data can be printed, screened or stamped.
f) To provide a pen gripping sleeve that is open at both top and bottom ends which permits the rapid insertion of a disposable stick pen or common pencil without any disassembly or reassembly required.

### SUMMARY

In accordance with the present invention a writing instrument gripping sleeve comprising of an elongated, substantially cylindrical, rigid body abutting a deformable and removable finger gripping element, the through bore being devoid of an ink reservoir.

### DRAWINGS

### Figures

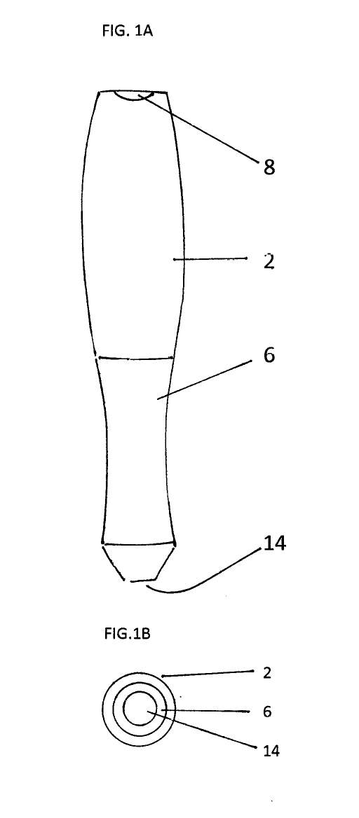

FIG. 1A—is a side view of the variable grip pen sleeve in an assembled

FIG. 1B—is a bottom end view of variable grip pen sleeve

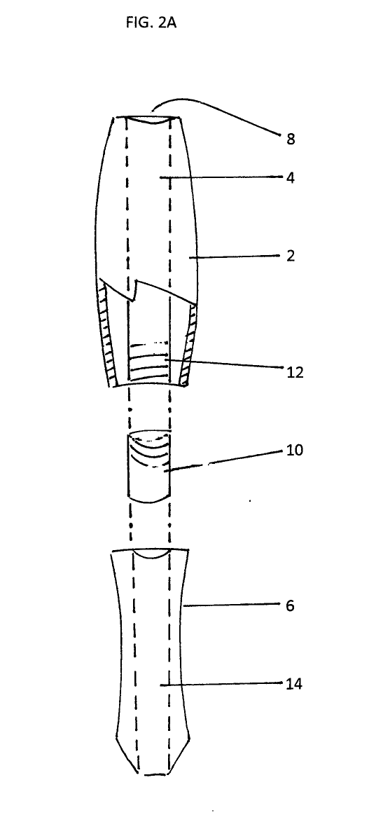

FIG. 2A—is an exploded, side elevation view of the preferred embodiment of the pen gripping sleeve with the removable grip component removed exposing a threaded connecting bushing and a cross section view of the rigid barrel (6) showing a threaded portion of the internal through bore.

### DRAWINGS

### Reference Numerals

2—rigid pen holder barrel

4—through bore of rigid barrel

6—deformable finger grip element

8—orifice of rigid barrel

10—threaded connector bushing

12—threaded segment of through bore

14—through bore of deformable finger grip

### DETAILED DESCRIPTION

A preferred embodiment of the variable grip pen sleeve of the present invention is illustrated in FIGS. 1A and 2A.

FIG. 1A

A substantially cylindrical rigid barrel (2) abuts a cylindrical, deformable finger grip element (6)

FIG. 1B

A bottom end view of the implement shows the through bore (14) of the finger grip element, the finger grip element (6) and the rigid barrel (2).

FIG. 2A Description of Connecting Arrangement

FIG. 2A shows an exploded view of the writing implement. Orifice (8) is the opening at the top end of the implement and leads to through bore(4) of the rigid barrel (2). A cross section view of the rigid barrel (2) exposes the internal through bore (4) which has a threaded segment (12) at the lower end. Bushing (10) is threaded for a portion of its length, its upper half, and would screw into the lower end of rigid barrel (2). Deformable finger grip element (6) has a through bore (14) which would accept the non-threaded portion of connector bushing (10). The bushing (10) would be permanently affixed into the deformable finger grip element (6) with adhesive. Thus the deformable finger grip element (6) can be installed then removed from the rigid barrel (2) at the user's discretion.

FIG. 2A Description of Through Bores

The inside diameter of through bore of the rigid barrel (4) would be formed to be greater than the outside diameter of disposable stick pens and common pencils. This allows a disposable stick pen to be inserted without any friction offered by the walls of the through bore (4).

The through bore of the bushing (10) would also be formed to permit a disposable stick pen or common pencil to pass through without resistance.

The inside diameter of the through bore (14) of the deformable finger grip element (6) would be formed to be less than the outside diameter of disposable stick pens and common pencils. This allows disposable pens or pencils inserted as refills to be captured by the deformable finger grip element (6).

Operation

The preferred ink cartridge to be used for this invention is an unassembled disposable stick pen, minus the cap. Any brand can be used as stick pens have similar outside diameters.

A disposable stick pen or common pencil would be inserted into orifice (8) and through bore (4). The inserted disposable stick pen or pencil would easily glide through the rigid barrel (2). Because the internal diameter of through bore (4) would be formed greater than the outside diameter of a disposable stick pen or common pencil, which have similar outside diameters, there would be no resistance offered.

As the disposable stick pen or common pencil is pushed further down the through bore of the invention the stick pen eventually reaches the deformable finger grip element (6). The finger grip element (6) is formed of an elastomer. Because the inside diameter of finger grip element (6) is formed to be less than the outside diameter of a disposable stick pen the stick pen now experiences resistance as it enters the narrower elastomeric, deformable finger grip element(6). The elastomer expands as it receives the inserted stick pen and offers radial friction. The stick pen is pushed through the elastomeric, deformable finger grip (6) until the ball point projects satisfactorily from the end of the finger grip element (6). The deformable finger grip element (6) applies radial pressure and friction to the stick pen and holds the pen in place within the entire device. The deformable elastomeric finger grip element (6) because of its high coefficient of friction within its interior walls is the only means for capturing and retaining the disposable stick pen or common pencil within the variable grip pen sleeve. Once pinch force is applied to the finger contact area with the writer's fingers the added radial pressure to the stick pen makes it virtually impossible to move the pen within the barrel of the invention.

To remove the stick pen from the device one must grasp the rigid barrel (2) and pull or push the stick pen out of the sleeve. The pen will slide out with ease as long as no finger pressure is applied to the deformable finger grip element (6).

### Alternative Embodiments

There are numerous ways to construct my invention as this would be obvious to those skilled in the relevant arts.
1. The preferred embodiment would be to form the rigid barrel (2) component employing an injection molding process with thermoplastic material. The barrel could also be formed using natural materials such as wood or bamboo employing a lathe turning process.
2. The deformable finger grip element (6) could be formed of a tubular extruded foam rubber employing a lathe and grinding process as is done with most foam rubber grips. This would be the preferred embodiment. Injection molding could be used to create finger grip elements of a deformable material such as vinyl or silicone. These materials have a higher durometer than foam rubber therefore are not as comfortable. Co-injection molding could also be employed to create a deformable finger grip where a deformable material is injection molded directly onto the bushing (10) component for a secure bond.

Advantages

From the description above a number of advantages of my writing instrument become evident:

(a) Ubiquitous disposable stick pens or common pencils of varying lengths can be rapidly inserted into the present invention because it is open ended.

(b) The deformable finger grip element provides enhanced comfort and tactility to the user.

(c) The deformable finger grip element being removably attached to the pen holder barrel could be offered in different diameters and densities to the advantage of the user.

(d) The rigid barrel offers a substantial area for promotional data to be printed upon it.

(e) The rigid barrel clement made of thermoplastic material of varying fashionable colors and designs would offer improved aesthetic appeal to a stick pen or pencil.

(f) The rigid barrel element could be modified and formed to create a secured pen device, one that is secured to a counter top by a chain, cable or cord thus broadening the utilitarian value of stick pens.

### CONCLUSION AND RAMIFICATIONS

The reader will see that the pen holder of this invention is superior to prior art in a number of ways.
It permits the rapid and easy insertion of a refill because it is open ended.
It provides a pen holder barrel that utilizes stick pens as the refill allowing for a high degree of convenience considering the ubiquitous nature of stick pens.
It provides a removable deformable gripping element of differing sizes which offers comfort and improved tactility according to the preferences of the individual user.
It provides a rigid, thermoplastic barrel element which covers a substantial portion of a stick pen or common pencil thus improving balance in a user's hand and provides an adequate surface area upon which to print or screen promotional data.
It provides a rigid pen holder barrel that can be modified to become a tethered security pen device.

I claim:

1. In a hand held pen grip sleeve comprising:
a) a longitudinal through bore devoid of an ink reservoir
b) an elongated, substantially cylindrical, rigid body abutting
c) an elongated, cylindrical, deformable, finger grip element
d) means for removing said finger grip element from said rigid body.

2. The hand held pen grip sleeve of claim 1 wherein said longitudinal through bore is sized and configured to accept disposable stick pens and common pencils as a refill.

3. The hand held pen grip sleeve of claim 1 wherein said deformable finger grip element has a longitudinal through bore formed to have an inside diameter to be less than the outside diameter of a disposable stick pen or a common pencil.
